(19) United States
(12) Patent Application Publication
(10) Pub. No.: US 2011/0051817 A1
(43) Pub. Date: Mar. 3, 2011

(54) VIDEO DECODER

(75) Inventor: Ryota Mizoguchi, Tokyo (JP)

(73) Assignee: OKI SEMICONDUCTOR CO., LTD., Tokyo (JP)

(21) Appl. No.: 12/854,929

(22) Filed: Aug. 12, 2010

(30) Foreign Application Priority Data
Aug. 25, 2009 (JP) 2009-194509

(51) Int. Cl. H04N 11/02

(52) U.S. Cl. 375/240.25; 375/E07.027

(57) ABSTRACT

A video decoder is provided which can convert analog composite video signals into noise-suppressed luminance and color difference signals without increasing the system in size. From the A/D converted composite video data, luminance component data carrying the luminance component and color difference component data carrying the color difference component are acquired. Then, dithering is performed on each piece of the luminance component data and the color difference component data for output as digital luminance and color difference signals.

### BACKGROUND OF THE INVENTION

1. Field of the Invention

The present invention relates to a video decoder which converts an analog video signal into a digital signal for output.

2. Description of the Related Art

Currently, known as such a video decoder is one which converts an input analog composite video signal into digital luminance and color signals for output. For example, see FIG. 3 in Japanese Patent Kokai No. 2002-223417 (Patent Document 1).

Such a video decoder has been commercially incorporated, for example, into a personal navigation device (PND). In this case, the display device (for example, the liquid crystal display) mounted on the PND is not required of a high image quality and thus configured to provide a small number of expressible luminance gray-scales, thereby realizing lower-price devices. Accordingly, even one-bit error (hereinafter referred to as noise), which has occurred during processing by the video decoder, would lead to a disturbance in image to such an extent that it can be recognized by the human eye.

### SUMMARY OF THE INVENTION

A video decoder according to an aspect of the present invention is provided which can convert an analog composite video signal into noise-suppressed luminance and color difference signals without increasing the system in size.

A video decoder according to an embodiment converts an analog composite video signal into digital luminance and color difference signals for output. The decoder includes: an A/D conversion part for converting the composite video signal into digital composite video data; a YC separator which separately extracts luminance component data carrying a luminance component and chrominance component data carrying a chrominance component from the composite video data; a color difference processing part which calculates color difference component data carrying a color difference component based on the luminance component data and the chrominance component data; and an output part which outputs each piece of the luminance component data and the color difference component data, after having been each dithered, as the luminance signal and the color difference signal.

A video decoder according to another embodiment converts an analog composite video signal into digital luminance and color difference signals for output. The decoder includes: an A/D conversion part for converting the composite video signal into digital composite video data; a YC separator which separately extracts luminance component data carrying a luminance component and chrominance component data carrying a chrominance component from the composite video data; a color difference processing part which calculates color difference component data carrying a color difference component data based on the luminance component data and the chrominance component data; and an output part which outputs a signal obtained by dithering only the luminance component data among pieces of the luminance component data and the color difference component data as the luminance signal and outputs a signal obtained by delaying the color difference component data by the time required for the dithering as the color difference signal.

When an analog composite video signal is converted into the digital luminance signal and the color difference signal, dithering is performed on the pieces of the luminance component data and the color difference component data which have been separately extracted from the A/D converted composite video data. This allows for making use of a small-scale arrangement to suppress noise which results from a conversion error caused by the A/D conversion part.

### BRIEF DESCRIPTION OF THE DRAWINGS

FIG. 1 is a diagram illustrating the overall configuration of an example of a video decoder according to the present invention;

FIG. 2 is a diagram illustrating an exemplary internal configuration of the output format conversion part 8 shown in FIG. 1;

FIG. 3 is a diagram illustrating another exemplary internal configuration of the output format conversion part 8 shown in FIG. 1; and

FIG. 4 is a diagram illustrating another exemplary internal configuration of the output format conversion part 8 shown in FIG. 1.

### DETAILED DESCRIPTION OF THE INVENTION

A video decoder of the invention acquires luminance component data carrying a luminance component and color difference component data carrying a color difference component from A/D converted composite video data. The decoder then performs dithering on each piece of the luminance component data and the color difference component data for output as digital luminance and color difference signals.

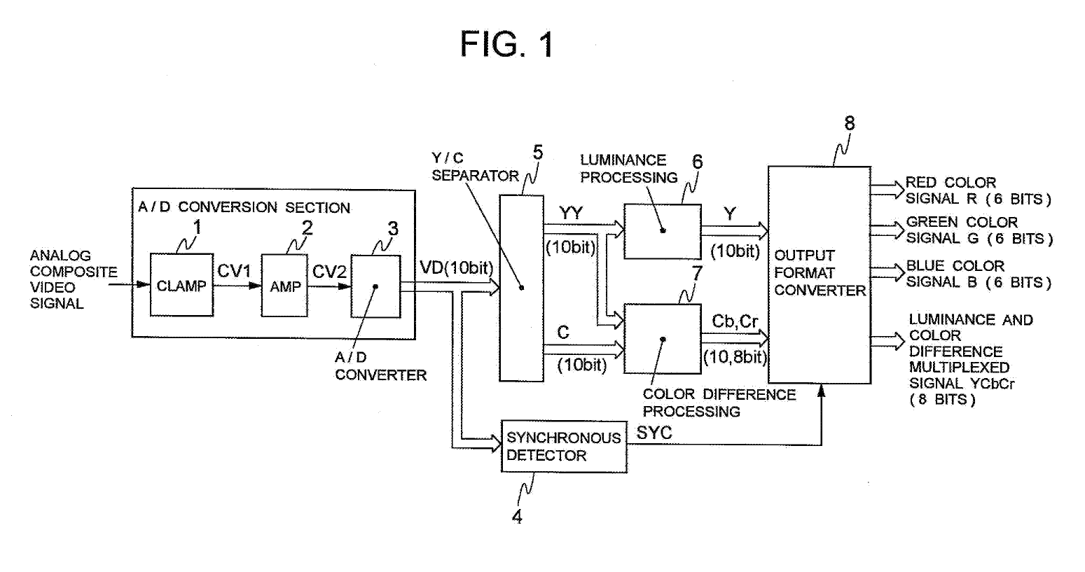

FIG. 1 is a diagram illustrating the overall configuration of an example of a video decoder according to the present invention.

As shown in FIG. 1, such a video decoder includes an A/D conversion part that has a clamp circuit 1, an amplifier 2, and an A/D converter 3; a synchronous detection part 4; a Y/C separator 5; a luminance processing part 6; a color difference processing part 7; and an output format conversion part 8.

The clamp circuit 1 clamps an input analog composite video signal CVBS to adapt its level to the dynamic range of the downstream A/D converter 3 and then supplies the resulting composite video signal CV1 to the amplifier 2. The amplifier 2 amplifies such a composite video signal CV1 as required and then supplies the resulting composite video signal CV2 to the A/D converter 3.

The A/D converter 3 samples the composite video signal CV2 to convert it into 10-bit digital composite video data VD for delivery to each of the synchronous detection part 4 and the Y/C separator 5.

The synchronous detection part 4 detects a sync signal from the composite video data VD and then supplies the detected sync signal as a sync signal SYC to the output format conversion part 8.

The Y/C separator 5 separates each of the luminance component and the chrominance component from the composite video data VD. Then, the separator 5 supplies 10-bit luminance data YY indicative of the luminance component to the luminance processing part 6 and 10-bit chrominance data C associated with the aforementioned chrominance component and the luminance data YY to the color difference processing part 7.

The luminance processing part 6 supplies the 10-bit luminance data Y obtained by adjusting the luminance level represented by the luminance data YY to the output format conversion part B.

The color difference processing part 7 subtracts the luminance level indicated by the luminance data YY from the blue color component represented by the chrominance data C to produce color difference data Cb. Additionally, the processing part 7 subtracts the luminance level indicated by the luminance data YY from the red color component represented by the chrominance data C to produce color difference data Cr. The color difference processing part 7 supplies the color difference data Cb (10 bits) and Cr (8 bits) to the output format conversion part 8.

In response to the sync signal SYC, the output format conversion part 8 converts the luminance data Y and the color difference data Cb and Cr into a red color signal R, a green color signal G, and a blue color signal B as shown below. Furthermore, in response to such a sync signal SYC, the output format conversion part 8 multiplexes the luminance data Y and the color difference data Cb and Cr to output a luminance and color difference multiplexed signal YCbCr.

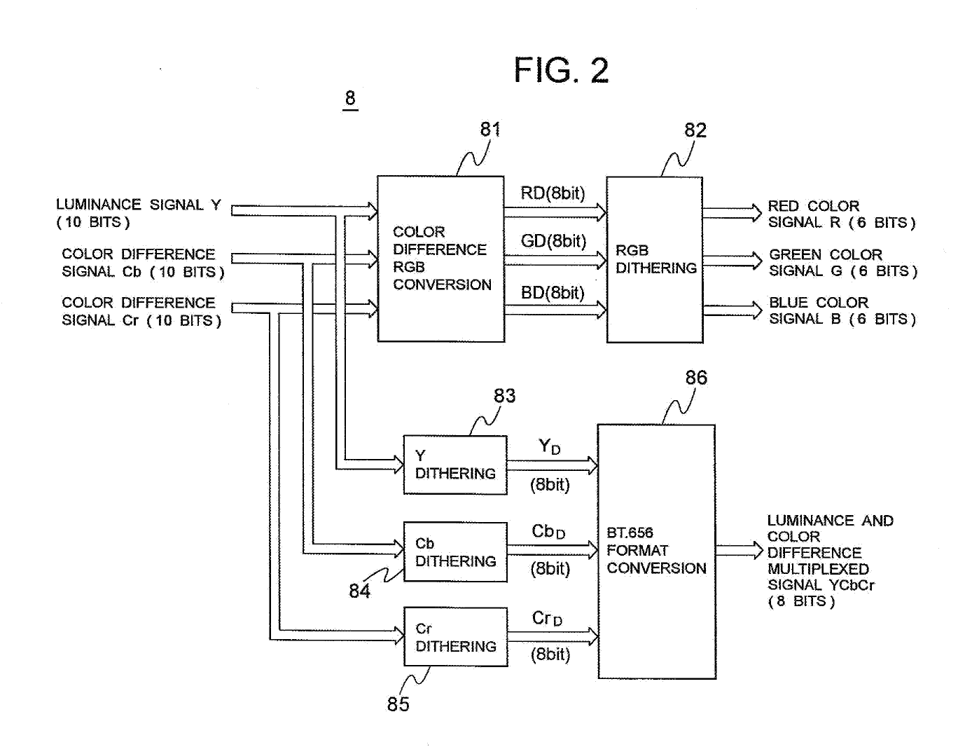

FIG. 2 is a diagram illustrating an exemplary internal configuration of the output format conversion part 8.

The output format conversion part 8 shown in FIG. 2 includes a color difference/RGB conversion part 81, an RGB dithering part 82, a Y dithering part 83, a Cb dithering part 84, a Cr dithering part 85, and a BT 656 format conversion part 86.

Based on the 10-bit luminance data Y supplied from the luminance processing part 6 and the 10-bit color difference data Cb and Cr supplied from the color difference processing part 7, the color difference/RGB conversion part 81 produces 8-bit red color data RD, green color data GD, and blue color data BD for delivery to the RGB dithering part 82.

For example, for each unit pixel block containing 4-row by 4-column pixels (an R, G, and B triad forms one pixel), the RGB dithering part 82 processes the red color data RD, the green color data GD, and the blue color data BD, each of which is 8-bit and supplied from the color difference/RGB conversion part 81, using a dither matrix in which the pixels within the unit pixel block are each assigned different dither values (for example, a value expressed in two bits). That is, the RGB dithering part 82 adds the dither value for each pixel represented by the aforementioned dither matrix to each piece of the red color data RD, the green color data GD, and the blue color data BD, each of which is associated with that pixel. Then, the dithering part 82 subtracts the two lowest-order bits from the result of each addition to output the red color signal R, the green color signal G, and the blue color signal B, each of which is 6-bit. Note that the two lowest-order bits include the lowest-order bit and the second lowest-order bit. By such dithering, the RGB dithering part 82 produces the red color signal R, the green color signal G, and the blue color signal B, which all have 6 bits but can represent a gray scale corresponding to 8 bits.

Based on the aforementioned dither matrix, the Y dithering part 83 processes the 10-bit luminance data Y supplied from the luminance processing part 6 as follows. That is, the Y dithering part 83 adds the dither value for each pixel expressed by the aforementioned dither matrix to the 10-bit luminance data Y associated with that pixel, and then subtracts the two lowest-order bits from the result of the addition, thereby producing 8-bit luminance data Y_{D}. By such dithering, the Y dithering part 83 produces the luminance data Y_{D} which has 8 bits but can represent a gray scale corresponding to 10 bits, and then supplies the 8-bit luminance data Y_{D} to the BT 656 format conversion part 86.

Based on the aforementioned dither matrix, the Cb dithering part 84 performs processing as follows on the 10-bit color difference data Cb supplied from the color difference processing part 7. That is, the Cb dithering part 84 adds the dither value for each pixel represented in the aforementioned dither matrix to the 10-bit color difference data Cb associated with that pixel. Then, the dithering part 84 subtracts the two lowest-order bits from the result of the addition, thereby producing the 8-bit color difference data Cb_{D}. By such dithering, the Cb dithering part 84 produces the color difference data Cb_{D} which has 8 bits but can represent a gray scale corresponding to 10 bits, and then supplies the 8-bit color difference data Cb_{D} to the BT 656 format conversion part 86.

Based on the aforementioned dither matrix, the Cr dithering part 85 performs processing as follows on the 10-bit color difference data Cr supplied from the color difference processing part 7. That is, the Cr dithering part 85 adds the dither value for each pixel represented in the aforementioned dither matrix to the 10-bit color difference data Cr associated with that pixel. Then, the dithering part 85 subtracts the two lowest-order bits from the result of the addition, thereby producing the 8-bit color difference data Cr_{D}. By such dithering, the Cr dithering part 85 produces the color difference data Cr, which has 8 bits but can represent a gray scale corresponding to 10 bits, and then supplies the 8-bit color difference data Cr_{D} to the BT 656 format conversion part 86.

The BT 656 format conversion part 86 multiplexes each piece of the luminance data Y_{D} and the color difference data Cb_{D} and Cr_{D} based on BT.656 as recommended by ITU-R (International Telecommunication Union Radio communications Sector) into the 8-bit luminance and color difference multiplexed signal YCbCr for output.

Here, the dithering by each of the RGB dithering part 82, the Y dithering part 83, the Cb dithering part 84, and the Cr dithering part 85 suppresses the noise which would otherwise result from the conversion error by the A/D conversion part.

That is, the conversion error by the A/D conversion part, which is primarily caused by a slight variation in the DC level of the clamp circuit 1, will lead to a variation, for example, in the two lowest-order bits of the composite video data VD or the output from the A/D converter 3. That is, the two lowest-order bits of the composite video data VD are superposed by the noise resulting from the conversion error by the A/D conversion part. After the dither value has been added, the dithering part (82 to 85) is to subtract the two lowest-order bits on which the noise has been superposed. Thus, the peak of the noise caused by the two lowest-order bits is suppressed, thereby allowing the luminance and color difference multiplexed signal YCbCr, the red color signal R, the green color signal G, and the blue color signal B to be provided without noticeable noise. In this case, since the noise resulting from the conversion error caused by the A/D conversion part is to be reduced by dithering, the system can be reduced in scale when compared to a case where the pieces of data of adjacent frames are compared with each other for noise reduction. Furthermore, the aforementioned dithering greatly reduces noise when the luminance level and the color difference level are constant across the screen, i.e., while still images such as so-called raster images are being displayed.

Note that the color difference/RGB conversion part 81 of the aforementioned embodiment converts the luminance data Y and the color difference data Cb and Cr, each of which is 10-bit, into 8-bit color data (RD, GD, and BD). However, it is also acceptable to use the conversion part 81 that can provide the red color data RD, the green color data GD, and the blue color data BD, each of which is 10-bit. At this time, the RGB dithering part 82 to be employed is to perform dithering as mentioned above on the red color data RD, the green color data GD, and the blue color data BD, each of which is 10-bit, thereby producing the red color signal R, the green color signal G, and the blue color signal B, each of which is 8-bit. This makes it possible to provide a 24-bit RGB signal (R in 8 bits, G in 8 bits, and B in 8 bits).

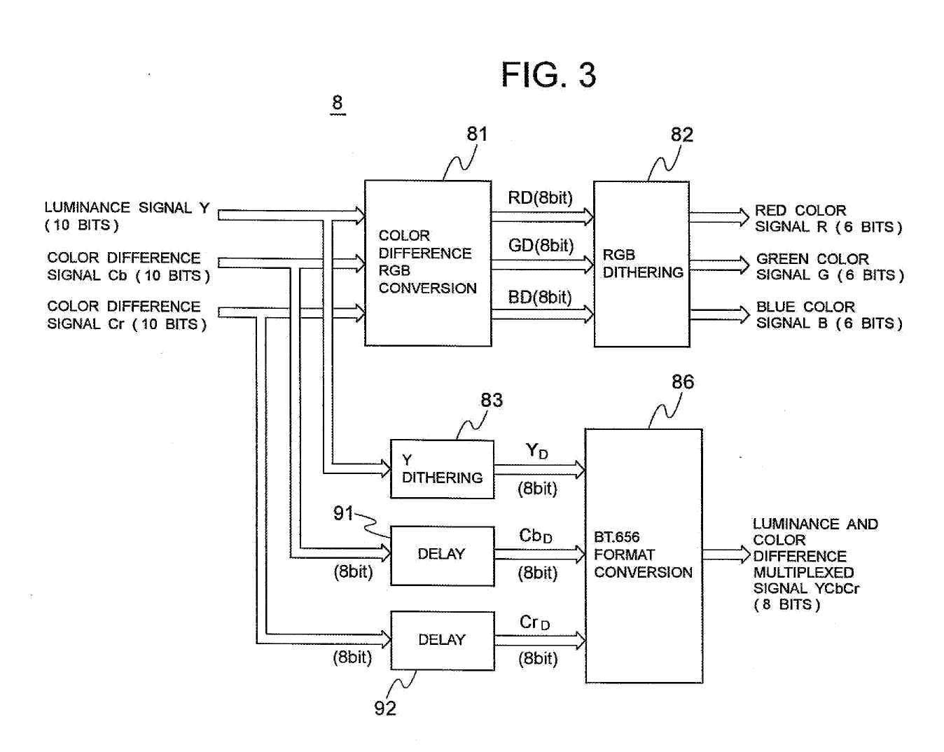

The output format conversion part 8 can be internally configured as shown in FIG. 3 instead of FIG. 2, thereby further reducing the circuit in scale.

The output format conversion part 8 having the internal configuration shown in FIG. 3 includes a delay circuit 91 instead of the Cb dithering part 84 shown in FIG. 2 and a delay circuit 92 instead of the Cr dithering part 85. Except for these circuits, the other components (such as the color difference/RGB conversion part 81, the RGB dithering part 82, the Y dithering part 83, and the BT 656 format conversion part 86) are the same as those shown in FIG. 2.

In FIG. 3, the delay circuit 91 delays the 8-bit color difference data Cb, supplied from the color difference processing part 7, by a predetermined time period to supply the resulting data as the color difference data Cb_{D} to the BT 656 format conversion part 86. The delay circuit 92 delays the 8-bit color difference data Cr, supplied from the color difference processing part 7, by a predetermined time period to supply the resulting data as the color difference data Cr_{D} to the BT 656 format conversion part 86. Note that the predetermined time period is the same as the processing time required for the Y dithering part 83 from the time the luminance data Y is supplied to the Y dithering part 83 until the luminance data Y_{D} is delivered corresponding to the supplied luminance data Y.

That is, in the configuration shown in FIG. 3, the luminance data Y and the color difference data Cb and Cr is multiplexed for output. At this time, dithering is performed only on the luminance data Y, among the luminance data Y and the color difference data Cb and Cr, to suppress noise which would otherwise result from a conversion error caused by the A/D conversion part.

That is, the dithering for reducing noise is to be performed only on the luminance data Y because of the following two reasons. One is that the degree of visual recognition of the color is approximately 1/100 of that of the luminance so that a chrominance component even with noise superposed will be hardly recognized. The other is that a slight variation in the DC level of the clamp circuit 1, which mainly causes the A/D conversion error, will affect only the luminance signal.

In comparison with the arrangement shown in FIG. 2, the structure shown in FIG. 3 includes additional components or the delay circuits 91 and 92; however, its total scale is reduced by the amount corresponding to the Cb dithering part 84 and the Cr dithering part 85 which are larger than the delay circuits 91 and 92 and can be eliminated.

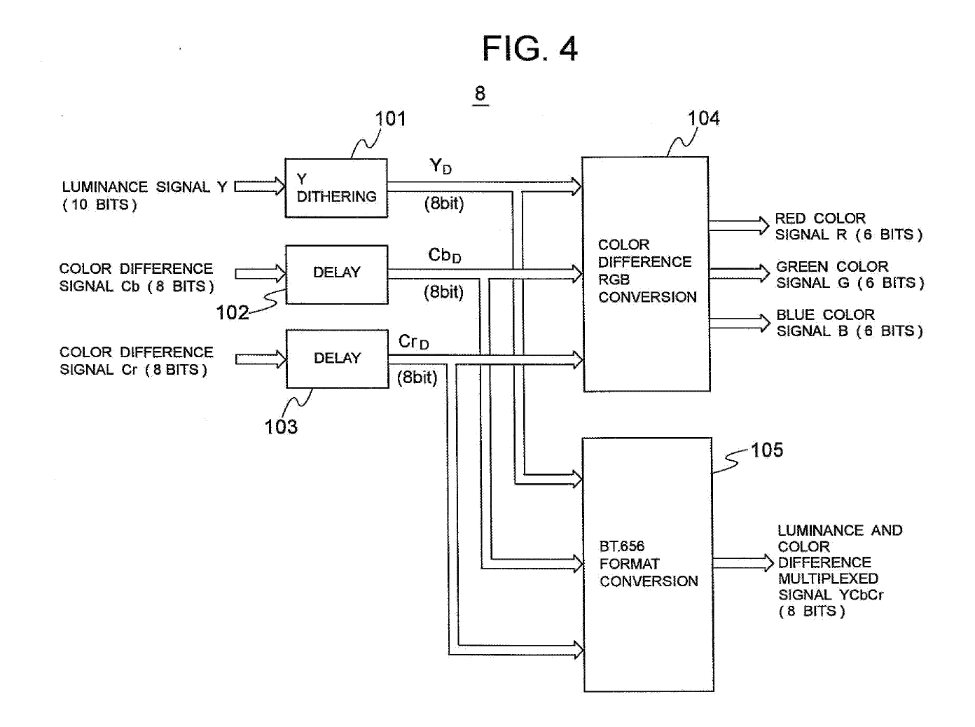

Furthermore, the output format conversion part 8 can be internally configured as shown in FIG. 4 instead of FIG. 3, thereby further reducing the circuit in scale.

The output format conversion part 8 having the internal configuration shown in FIG. 4 includes a Y dithering part 101, a delay circuit 102, a delay circuit 103, a color difference/RGB conversion part 104, and a BT 656 format conversion part 105.

For example, for each unit pixel block containing 4-row by 4-column pixels (an R, G, and B triad forms one pixel), the Y dithering part 101 processes the 10-bit luminance data Y supplied from the luminance processing part 6 using a dither matrix in which the pixels within the unit pixel block are each assigned different dither values (for example, a value expressed in two bits). That is, the Y dithering part 101 adds the dither value for each pixel represented in the aforementioned dither matrix to the 10-bit luminance data Y associated with that pixel. Then, the dithering part 101 subtracts the two lowest-order bits from the result of the addition to produce the 8-bit luminance data Y_{D}. By such dithering, the Y dithering part 101 produces the luminance data Y_{D} which has 8 bits but can represent a gray scale corresponding to 10 bits, and then supplies the 8-bit luminance data Y_{D} to each of the color difference/RGB conversion part 104 and the BT 656 format conversion part 105.

The delay circuit 102 delays the 8-bit color difference data Cb supplied from the color difference processing part 7 by a predetermined time period to produce the color difference data Cb_{D}, which is then supplied to each of the color difference/RGB conversion part 104 and the BT 656 format conversion part 105. The delay circuit 103 delays the 8-bit color difference data Cr supplied from the color difference processing part 7 by a predetermined time period to produce the color difference data Cr_{D}, which is then supplied to each of the color difference/RGB conversion part 104 and the BT 656 format conversion part 105. Note that the predetermined time period is the same as the processing time required for the Y dithering part 101 from the time the luminance data Y is supplied to the Y dithering part 101 until the luminance data Y_{D} is delivered corresponding to the supplied luminance data Y.

The color difference/RGB conversion part 104 produces and outputs the red color signal R, the green color signal G, and the blue color signal B, each of which is 6-bit, based on the 8-bit luminance data Y_{D} supplied from the Y dithering part 101, the 8-bit color difference data Cb_{D} supplied from the delay circuit 102, and the 8-bit color difference data Cr_{D} supplied from the delay circuit 103.

The BT 656 format conversion part 105 multiplexes each piece of the luminance data Y_{D} and the color difference data Cb_{D} and Cr_{D} based on BT.656 as recommended by ITU-R into the 8-bit luminance and color difference multiplexed signal YCbCr for output.

As with the arrangement shown in FIG. 3, the aforementioned dithering to suppress noise is performed only on the luminance data Y obtained by Y/C separation and on the luminance data Y within the color difference data Cb and Cr in the arrangement shown in FIG. 4. However, in the arrangement shown in FIG. 4, the process performs the BT 656 format conversion (105) in conjunction with the RGB conversion (104) based on the dithered luminance data Y and the undithered color difference signals (Cb_{D} and Cr_{D}).

Thus, the arrangement shown in FIG. 4 makes it possible to reduce the circuit in scale by the amount corresponding to the RGB dithering part 82 that can be eliminated, as compared to the arrangement shown in FIG. 3 where the dithering is performed on the RGB converted color data (RD, GD, and BD).

This application is based on Japanese Patent Application No. 2009-194509 which is herein incorporated by reference.

What is claimed is:

1. A video decoder for converting an analog composite video signal into digital luminance and color difference signals for output, the video decoder comprising:
an A/D conversion part for converting the composite video signal into digital composite video data;
a YC separator which separately extracts luminance component data carrying a luminance component and chrominance component data carrying a chrominance component from the composite video data;
a color difference processing part which calculates color difference component data carrying a color difference component based on the luminance component data and the chrominance component data; and
an output part which outputs each piece of the luminance component data and the color difference component data, after having been each dithered, as the luminance signal and the color difference signal.

2. The video decoder according to claim 1, wherein
for each unit pixel block, the output part adds a dither value pre-assigned to each pixel within the unit pixel block to each piece of the luminance component data and the color difference component data associated with that pixel, and outputs a result of the addition from which a group of lower-order bits has been subtracted as the luminance signal and the color difference signal, the group of lower-order bits having superposed noise resulting from a conversion error caused by the A/D conversion part.

3. The video decoder according to claim 1, wherein the output part multiplexes the luminance signal and the color difference signal for output.

4. A video decoder for converting an analog composite video signal into digital luminance and color difference signals for output, the video decoder comprising:
an A/D conversion part for converting the composite video signal into digital composite video data;
a YC separator which separately extracts luminance component data carrying a luminance component and chrominance component data carrying a chrominance component from the composite video data;
color difference processing part which calculates color difference component data carrying a color difference component data based on the luminance component data and the chrominance component data; and
an output part which outputs a signal obtained by dithering only the luminance component data among pieces of the luminance component data and the color difference component data as the luminance signal, and outputs a signal obtained by delaying the color difference component data by a time period required for the dithering as the color difference signal.

5. The video decoder according to claim 4, wherein
for each unit pixel block, the output part adds a dither value pre-assigned to each pixel within the unit pixel block to the luminance component data associated with that pixel, and the result of the addition from which a group of lower-order bits has been subtracted is output as the luminance signal, the group of lower-order bits having superposed noise resulting from a conversion error caused by the A/D conversion part.

6. The video decoder according to claim 4, wherein
the output part further includes a part which produces and outputting a red color signal indicative of a red color component, a green color signal indicative of a green color component, and a blue color signal indicative of a blue color component based on the luminance component data and the color difference component data.

7. The video decoder according to claim 4, wherein the output part multiplexes the luminance signal and the color difference signal for output.
